(19) United States
(12) Patent Application Publication
(10) Pub. No.: US 2006/0116915 A1
(43) Pub. Date: Jun. 1, 2006

(54) Blanket insurance method and policy for insuring multiple unit dwellings

(75) Inventors: Nick J. Colessides, Salt Lake City, UT (US); Welden L. Daines, Bountiful, UT (US); Don Taylor, Salt Lake City, UT (US); Marcellus Barrus, Salt Lake City, UT (US)

Correspondence Address: MARCUS G THEODORE, PC, 466 SOUTH 500 EAST, SALT LAKE CITY, UT, 84102, US

(73) Assignee: Renters Legal Liability, LLC, Salt Lake City, UT (US)

(21) Appl. No.: 11/332,445

(22) Filed: Jan. 13, 2006

Related U.S. Application Data
(63) Continuation-in-part of application No. 11/274,875, filed on Nov. 15, 2005.
Application No. 11/274,875 is a continuation-in-part of application No. 11/134,643, filed on May 23, 2005.
Application No. 11/134,643 is a continuation-in-part of application No. 11/020,152, filed on Dec. 27, 2004.
Application No. 11/020,152 is a continuation-in-part of application No. 09/947,330, filed on Sep. 7, 2001.
Application No. 09/947,330 is a continuation-in-part of application No. 09/921,251, filed on Aug. 3, 2001, now abandoned.
Application No. 09/921,251 is a continuation-in-part of application No. 09/476,559, filed on Jan. 3, 2000, now abandoned.

(51) Int. Cl. G06Q 40/00

(52) U.S. Cl. 705/4

(57) ABSTRACT

A blanket insurance method and policy for insuring the owner of an apartment or multi-unit dwelling from damage to his building caused by his tenant's unintentional acts comprising: inputting into a computer processor a database of building physical information, occupancy information, and tenant rental information; inputting into the computer processor an insurance qualification program for renters legal liability insurance covering the building owner from unintentional damage caused by the tenant from fire, smoke, explosions, water damage, or negligence injuries by the tenant caused to third parties pursuant to predetermined insurability criteria; qualifying the building for renters legal liability insurance, and computer translating and generating insurance coverage for the building owner based on the number of units in the building and insurance coverage limits desired, and billing the owner for renter's legal liability insurance.

### RELATED APPLICATIONS

This application is a continuation-in-part of the continuation-in-part application of United States Letters Patent entitled METHOD AND APPARATUS FOR INSURING MULTIPLE UNIT DWELLINGS, filed Nov. 15, 2005, Ser. No. 11/274,875 of the continuation-in-part application entitled METHOD AND APPARATUS FOR INSURING MULTIPLE UNIT DWELLINGS, filed May 5, 2005, Ser. No. 11/134,643 of the continuation-in-part of the continuation-in-part application of United States Letters Patent entitled METHOD AND APPARATUS FOR INSURING MULTIPLE UNIT DWELLINGS, filed Dec. 27, 2004, Ser. No. 11/020,152 of the continuation-in-part of the continuation-in-part application filed Jul. 7, 2001, Ser. No. 09/947,330 entitled “Method and Apparatus for Insuring Multiple Unit Dwellings” of the continuation-in-part application filed Aug. 3, 2001, Ser. No. 09/921,251 entitled “Method and Apparatus for Insuring Multiple Unit Dwellings” of the original application entitled “Method and Apparatus for Insuring Multiple Unit Dwellings”, Ser. No. 09/476,559 filed Jan. 3, 2000.

### BACKGROUND OF THE INVENTION

1. Field

This invention relates to methods for insuring owners of and tenants occupying multiple unit dwellings and buildings. More particularly, it relates to a method and policy to insure the owner and tenants within apartments or multi-unit dwellings from accidental losses caused by the tenant.

2. State of the Art

Joint insurance coverage for owners of and tenants occupying multiple dwelling units in a building is currently not possible to write, because it is cost prohibitive to issue a large number of small policies covering individual units. Further, many lease clauses require renter's insurance coverage. However, approximately 90% of the 35 million apartment units in the United States are currently uninsured. Landlords currently do not have a process to verify or enforce the lease requirements of mandatory insurance. This places an enormous burden on the insurance agent to try and maintain adequate insurance coverage for the building owner. There is currently no insurance liability trail back to the tenant. Nor is there a product or method currently available to mass insure all tenants of an apartment building or multiple unit dwelling complexes. Renters insurance, unlike homeowners insurance, which normally has a third party, the mortgagee, as the enforcer, has currently no means of enforcement. This being the case, present insurance methods do not allow insurance companies to apply the principles of large numbers. The principle of large number provides for the spread of risk over members of a similar pool, allowing insurance companies to actuarially lower costs, increase profits and improve service.

The patent references of record fail to suggest insurance coverage to protect both the landlord and tenant from negligent acts by the tenant that affect the building owner from unintentional tenant acts causing fire, smoke, explosion and water damage to the building units, whether occupied or not. Luchs et al, U.S. Pat. No. 4,831,526 issued in 1989 discloses a computerized insurance premium quote request and policy issuance system primarily for use in the automotive, watercraft, dwelling, and personal liability insurance area. The method disclosed provides for preparing and writing insurance contracts via computer terminals and correction displays before printing out the policy. It does not address providing limited streamlined multi-unit coverage to provide reduced group rate insurance to building owners.

Dillard, U.S. Pat. No. 6,236,973B1 issued May 22, 2001 is an apparatus and method for providing collateral construction loan insurance coverage. It addresses a centralized automated apparatus for lending institutions to track insurance coverage on buildings used as collateral for construction loans under a single builder's risk policy. This apparatus provides management reports for the lending institution, and tracks premium payments and repayments for closed loans, and loss evaluations. Again, this reference does not address providing limited streamlined multi-unit group multi-unit coverage to provide reduced group rate insurance to building owners.

Brown et al., U.S. Pat. No. 5,978,769 issued Nov. 2, 1999 is a system and method for determining and analyzing building occupancy using geographically based structures to identify potential clients, perform carrier exposure aggregation and associated with operations performed by other occupants. This reference does not address issuing limited streamlined multi-group multi-unit coverage for the building owner, but is used as an actuarial risk-assessment rating tool.

Other business method patents address using computers to gather information from building sales and complexes to generate reports, which value and manage business complexes based on information concerning each unit in the building. Weatherly et al, U.S. Pat. No. 6,023,687 issued Feb. 8, 2000, utilizes a computerized system and method for creating and managing lease agreements. This patent tracks lease payments, issues lease policies, and provides periodic reports. It also incorporates telecommunication links between lessor computers and the lease control computer.

The Joao (U.S. Pat. No. 6,347,302) Labadorf et al. (Lead Paint Removal: What Insurers Won't Tell You!) and Merritt Editors (How to Insure Your Home) references previously cited by the Examiner in the parent application to preliminarily reject applicant's insurance method discuss insured occupied homeowners and lessee's premises insurance providing coverage for protecting individuals and/or business entities from liability which may arise as the result of excess wear and tear and/or damage which may occur to a leased and/or rented entity during the lease and/or rental term, and further for protecting individuals and/or business entities from liability for post-warranty repairs. The Joao, Labadorf and Merritt insurance products and method rely on an actuarial risk evaluation of dwelling units occupied by the owner or lessee of the unit. The insured was limited to those who actually occupied premises. Previously, it was believed that insured occupied dwelling units were subject to more control and monitoring to minimize risk and losses to the real estate.

Damage exposure for the owner who did not occupy units was thus not included in these homeowner insurance products. Nor was the owner of a multi-unit building covered for the actions of a tenant in his building.

Joao, provides an apparatus and a method . . . for providing insurance products, services and/or coverage which provides insurance coverage for protecting individuals and/or business entities from liability which may arise as the result of excess wear and tear and/or damage which may occur to a leased and/or rented entity during the lease and/or rental term, and further for protecting individuals and/or business entities from liability for post-warranty repairs, Col. 2, lines 8-17. As such, it is a named peril type of insurance coverage limited in scope to those perils described (excess wear and tear and/or damage which may occur during the lease and/or rental term). Joao does not teach a method wherein the type of insurance generated includes coverage to protect the multi-unit dwelling building owner from unintentional damage caused by his tenants from fire, smoke, explosions or water damage, or from negligence injuries caused to third parties, page 13 last paragraph Office Action mailed Mar. 24, 2004 in the parent application No. 09/921,251. Nor do Labadorf et al. teach this deficiency. Labadorf et al. discusses submittal of claims for lead contamination under all risk types of home owner's insurance policies, see page 2, numbered paragraph 16 discussing the 1973 comprehensive general liability policy.

Nor does the “How to Insure Your Home”, Merritt Publishing, Santa Monica, Calif. publication (Merritt) supply these deficiencies. Merritt discusses standard homeowner's insurance policies for condominium owners. Standard homeowner's insurance provides insurance coverage to the owner occupant of the property in accordance with the terms of the insuring agreement. The Merritt publication thus addresses a particular type of owner occupied insurance, which is not similar to applicant's insurance coverage for the building owner of multi-unit dwellings, such as apartment houses, where the owner most likely will not occupy the premises.

Cited for general interest are: Weatherly et al, U.S. Pat. No. 6,049,784 issued Apr. 11, 2000 and 6,023,687 issued Feb. 8, 2000 provide predetermined financial information regarding a potential tenant and a potential landlord to a lease control intermediary, and uses computers to evaluate the information to determine the acceptability of the financial risk associated with the potential tenant. It creates a service product in the form of a rent guaranty of periodic lease payments from the lease control intermediary to the landlord. A computer is incorporated into the method for creating and managing the lease agreement, if review of the tenant data falls within acceptable pre-programmed risk levels.

Hough, U.S. Pat. No. 5,414,621 issued May 9, 1995 provides a system and method for computing a comparative value of real estate based on assessment percentages and sales data of comparable properties using a computer and a multiple listing computer database. Information from various building sales is then used to determine “assessed value” and “phase value” based on price/tax factors.

Apgar, IV, U.S. Pat. No. 5,680,305 issued Oct. 21, 1997 provides another system and method for evaluating real estate based on amount, price, area, grade, and risk to provide a scoring rating system to provide a well-rounded picture of a particular real estate situation.

Rothstein, U.S. Pat. No. 6,058,369 issued May 2, 2000 disclosed a method and apparatus for monitoring the strength of a real estate market to make lending and title insurance decisions based upon a derived market index.

The method and apparatus described below provides insurance coverage to protect both the landlord and tenant from negligent unintentional tenant acts causing fire, smoke, explosion and water damage to the building units.

### SUMMARY OF THE INVENTION

The invention comprises a blanket insurance method for insuring an apartment or multi-unit dwelling unit with renters legal liability insurance covering the building owner from unintentional damage caused by the tenant from one or more of the perils selected from the group comprising fire; smoke; explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures, pursuant to predetermined insurability criteria. It comprises selecting objective building insurability criteria from a set of absolute insurance standards, such as the four basic types of construction recognized in fire insurance rating: A, B, C, and D, and class of occupancy, including physical information, the number of units in the apartment complex or multi-unit dwelling complex to qualify the complex for fire insurance coverage, actuarial insurance rates for renter's legal liability insurance, and other relevant information. The apartment or multi-unit dwelling is then qualified in accordance with the objective building physical information, number of units, and the tenant data for renters' legal liability insurance to issue pursuant to predetermined objective insurability criteria for the locale. After qualification, tenant insurance is then issued covering the building owner and/or property manager of the complex from the perils selected from the group comprising fire; smoke; explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures at a rate based on the number of insured units. The owner is then billed for the renter's legal liability insurance coverage.

This blanket insurance method may be performed without a technological aspect or via computer assistance. Examples of computer methods and apparatus to perform the blanket insurance method are found in the co-pending parent applications upon which this application is dependent.

The blanket insurance method building physical information generally comprises the full name of the insured, the mailing addresses of the building units, the number of buildings and units, the fire insurance policy on the building and rating by the four basic types of construction recognized in fire insurance coverage and including building owner coverage for negligence injuries by the tenant caused to third parties.

In addition to billing for the insurance, commission and management fees may be added to the actuarial insurance rates for inclusion in the billings of the owner.

The tenant insurance information generally includes tenant rental information, which may include lease agreement requirements, the limits of coverage, a credit report on the tenant coded to meet legal confidentiality requirements, a criminal background check of the tenant, and a character reference check of the tenant to verify his past tenant conduct.

Usually the building physical information and tenant rental information is inputted monthly, but can be inputted more often, particularly if the blanket insurance method employs a computer network with continually updated data bases.

The renters' legal liability insurance of the blanket insurance method generally covers both the owner and the tenant and the tenant's personal property within the unit. The blanket insurance method may also include generating tenant occupancy insurance which provides a pre-set amount of coverage for displaced tenants, and an additional sum for living expenses to the tenant unintentionally causing damage to the dwelling unit.

This renter's legal liability insurance usually covers the building owner's property for replacement cost, and may include tenant occupancy insurance with disability coverage, which pays the lease payment in the event an insured tenant is disabled, or also provides income benefits to the disabled tenant, and an accidental death benefit payable to a beneficiary in the event of death of the tenant.

The owner is generally billed for renters' legal liability and/or tenant occupancy insurance to be paid by the tenant on lease renewal or generation.

The provider of the renters legal insurance may provide credits against policies covering the property owner who has 100% of the tenants' units insured.

The tenant occupancy insurance of the method may include traditional HO-4 form policy coverage for the tenant. The renter's legal liability insurance policy is issued in a permanent written or unalterable media embodiment listing the coverage provided covering the unit. This renter's legal liability insurance policy often includes additional tenant occupancy insurance coverage, which also covers the tenant and the tenant's personal property in addition to damage to the unit.

The tenant occupancy insurance coverage policy may allow the tenant to acquire coverage by paying an additional insurance premium as part of the unit rent.

However, each blanket insurance policy provides at a minimum renters legal liability insurance to protect the landowner from unintentional damage caused by the tenant from two or more the perils selected from the group comprising fire, smoke, explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures, and negligence injuries by the tenant caused to third parties pursuant to predetermined insurability criteria.

In other blanket insurance method policies the renters liability insurance protects the owner from unintentional damage caused by the tenant from three or more perils selected from the group comprising fire, smoke, explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures, and negligence injuries by the tenant caused to third parties pursuant to predetermined insurability criteria.

In still other blanket insurance method policies the renters liability insurance protects the owner from unintentional damage caused by the tenant from four or more perils selected from the group comprising fire, smoke, explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures, and negligence injuries by the tenant caused to third parties pursuant to predetermined insurability criteria.

Prior to applicant's blanket insurance method, no insurance product provided insurance covering multi-unit dwelling building owners from unintentional damage caused by tenants from fire, smoke, explosions, and water damage, or negligence injuries by the tenant caused to third parties pursuant to predetermined insurability criteria. The policy is presently in existence and is therefore actually reduced to practice. None of the references cited above present evidence of similar insurance coverage. More importantly, no previous policies similar to the present invention were reduced to practice to anticipate or suggest the invention and insurance method. As a new insurance product and method, there is no previous evidence of prior combinations of references reduced to practice covering similar perils and insurance contract provisions to anticipate or suggest the invention.

Based on the RLL building coverage, the tenant may apply for tenant occupancy insurance (TOI). This coverage would be similar to a present renter's homeowner's policy. Coverage could include tenant property, liability to a third party and damage to the apartment building pursuant to predetermined insurability criteria. As TOI insurance is an add-on to the RLL building, it may be written at a group rate, thereby allowing the tenant a more affordable rate than heretofore available. The reason is because TOI insurance pricing is based on larger numbers of the entire building complex rather than the traditional underwriting for only one specific unit. This results in a larger insurance coverage pool lowering costs to issue, administer and cover any losses incurred in the building complex. The exact premium for TOI insurance coverage is also dependent upon the limits of coverage for personal property specified by the tenant. By limiting the extent of coverage, TOI insurance pricing is not open ended; thereby further reducing the premium charged. In addition, the premium rates for RLL coverage on the building owner may be reduced, depending upon the percentage of units in the building, which are additionally covered by TOI insurance. The blanket insurance method can therefore either be performed manually or with a computer to take advantage of the law of large numbers providing universal, capped, add on insurance coverage to the occupants of entire building at a very low cost as described in the Renters Legal Liability LLC co-pending patent applications:

METHOD AND APPARATUS FOR INSURING MULTIPLE UNIT DWELLINGS, filed Nov. 15, 2005, Ser. No. 11/274,875 of the continuation-in-part application entitled

METHOD AND APPARATUS FOR INSURING MULTIPLE UNIT DWELLINGS, filed May 5, 2005, Ser. No. 11/134,643 of the continuation-in-part of the continuation-in-part application of United States Letters Patent entitled

METHOD AND APPARATUS FOR INSURING MULTIPLE UNIT DWELLINGS, filed Dec. 27, 2004, Ser. No. 11/020,152 of the continuation-in-part of the continuation-in-part application filed Jul. 7, 2001, Ser. No. 09/947,330 entitled

METHOD AND APPARATUS FOR INSURING MULTIPLE UNIT DWELLINGS of the continuation-in-part application filed Aug. 3, 2001, Ser. No. 09/921,251 entitled

METHOD AND APPARATUS FOR INSURING MULTIPLE UNIT DWELLINGS of the original application entitled

METHOD AND APPARATUS FOR INSURING MULTIPLE UNIT DWELLINGS, Ser. No. 09/476,559 filed Jan. 3, 2000.

The blanket insurance method employs objective criteria dependent upon “Building Physical Information” about the apartment complex or multi-unit dwelling complex from all owners and business managers seeking insurance coverage within a geographical area. This information is reviewed and updated monthly, and contains the full name of the insured, the mailing addresses of the units, and the number of buildings. Additional information can be inputted such as the fire insurance policy on the building and building rating by the four basic types of construction recognized in fire insurance coverage—i.e. a Class A building is one with walls, floors, and roof of masonry or concrete, and with all load walls supported by an independent steel frame. A Class B structure is similar to Class A except that interior walls and floors are not constructed of masonry or concrete. A Class C building does not meet all specific requirements of Class B. A Class D building generally refers to frame structures and includes most private residences.

It also employs objective “Occupancy Information” about the apartment complex or multi-unit dwelling complex from all owners and business managers seeking insurance coverage within a geographical area specifying the total number of units occupied, and the total number of units vacant at the last reporting period.

In addition objective “Tenant Rental Information” may be utilized from all owners and business managers and tenants within a geographical area seeking insurance coverage containing the lease agreement requirements, a credit report on the tenant coded to meet legal confidentiality requirements, a criminal background check of the tenant, and a character reference check of the tenant to verify his past tenant conduct.

The above objective criteria are then measured against the building owner's particular property to qualify the building for renter's legal liability coverage (RLL), which begins on the date of occupancy and after data has been entered and qualified for coverage, and ends as of the date the tenant leaves and is removed from coverage. Continuous monitoring insures that empty units are not covered, and that the current tenant is covered as an additional insured. This lowers the overall cost of insurance to the owner by avoiding payment for non-existent insurance coverage on empty units. This may be done manually or electronically via a computer.

RLL, unlike other off the shelf products, is specifically designed to cover the multi-unit property owner from tenant liability as a single interest product. Off the shelf products do not allow this provision for the reason that the tenant is the named insured instead of an added insured. As previously stated, as named insured, the building owner is only protecting its interests and as such does not need to be a licensed insurance agent. Contractually tenant agrees to allow landlord to add their unit to the landlord's master policy.

The tenant's rent payment includes the renter's legal liability insurance coverage acquired by the landlord as named insured. This charge is added to the monthly rent bills a surcharge for the added insurance coverage.

The second step of the method is comprised of first compiling, inputting and expanding the database of tenant insurance information into a computer processor. A matching program is then inputted into the computer processor to repeatedly sort by building address a working database of the insurance status of each tenant. To insure the accuracy of the database, a statistical sampling and verification of the data provided is periodically performed.

The computer processor then generates a real time series of reports to the building owner, business manager, and various insurance carriers listing all of the insured and uninsured tenants of an apartment complex or multi-unit dwelling. Expired tenant insurance lists including but limited to self-purchased TOI and traditional HO-4 insurance may also be sent to these parties.

The insurance carrier generally pre-qualifies the apartment complex or multi-unit dwelling for renter's legal liability insurance, or tenant occupancy insurance via an actuarial assessment computer program inputted into the computer processor that establish the premiums required for each building. This qualification is generally conditioned on periodic updates of the database being provided by the building owner or manager that the occupancy and types of tenants do not materially fall to unacceptable levels. Once the building is pre-qualified, tenant risk will be insured against by renter's legal liability insurance when the tenant rents an apartment or dwelling unit. This renter's legal liability insurance will provide coverage to protect the landlord from unintentional acts of his tenants. RLL coverage is limited to the perils of fire, smoke, explosion and water damage, as well as liability incurred by the tenant so that the coverage can be automatically pre-approved and extended without any independent review triggered by additional risk factors involved in coverages, such as bodily injury. Typically, RLL insurance is capped at the value of the apartment unit, or a pre-set limit. For example, replacement cost as opposed to Actual Cash Value representing the depreciated value of the building in the event of loss could be specified to cover the real property to avoid a financial burden on the building owner in the event of loss. Actual cash value cost would still be specified for the tenants' personal property to eliminate any financial incentives for the tenants to start a fire to replace worn out personal property.

RLL insurance can be purchased incrementally to only cover units occupied by tenants or on a blanket policy basis covering all of the units in a multi-unit apartment or dwelling. The incremental purchase method progressively covers the entire complex as the units become fully occupied to become a blanket policy. In addition, the insurance actuarial rates per unit may include additional management and commission fees for administering the RLL insurance policy as a cost in the fees charged the owner and tenants for RLL insurance coverage.

RLL insurance also includes the good neighbor coverage which provides $1000 displacement costs for any non-negligent effected tenant and the negligent tenant.

Alternatively, the tenant may elect to participate in tenant occupancy insurance provided through the building owner. This allows the tenant to purchase insurance through a rent surcharge to cover tenant liability and personal property. The amounts of coverage for the building units are pre-approved by the insurance carrier and listed on internet screens. The tenant then simply checks the coverage desired, and the bill is added to the monthly rent charge.

Premiums are then periodically generated and billed to the building owner and tenant based on tenant occupancy and preferences at the end of each payment period. This allows the building owner the option to pay for insurance as the leases are renewed, rather than paid in advance. The method does not contemplate any earned premium at the inception for the reason that RLL insurance is mandatory and not optional unless the resident can prove similar insurance coverage is already in place. The blanket insurance method allows the building owner or manager to minimize the exposure from accidental tenant damage and provide another source of recovery in the event of loss.

### DESCRIPTION OF THE DRAWINGS

FIG. 1 illustrates a schematic flow diagram of a preferred blanket insurance method. FIG. 2 illustrates schematic flow diagram of a preferred configuration of the apparatus.

### DESCRIPTION OF THE ILLUSTRATED EMBODIMENTS

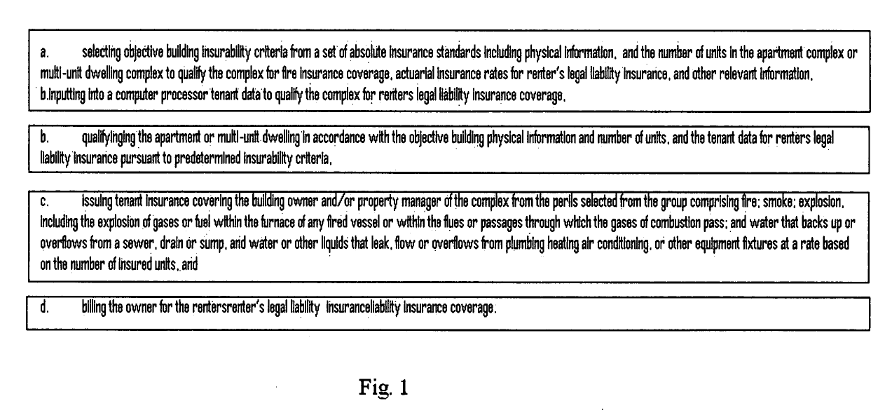

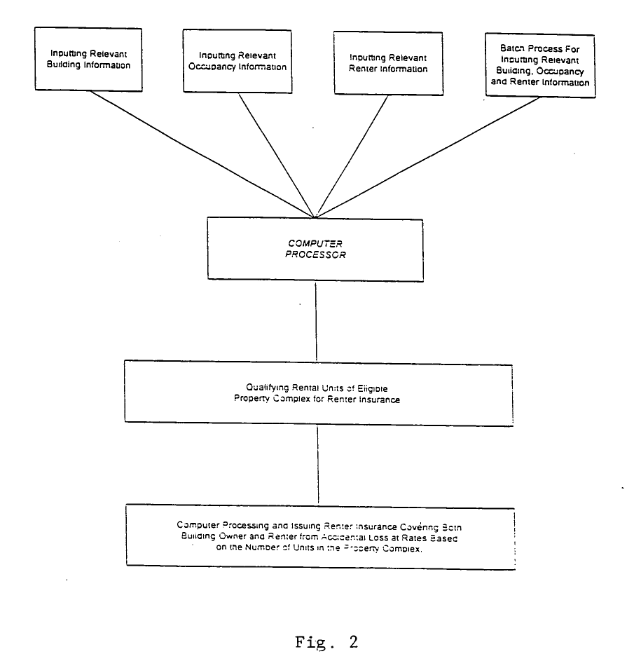

FIG. 1 illustrates a schematic flow diagram of the basic preferred overall blanket insurance method and legal liability policy implemented manually or via computer. The first phase of the method comprises selecting objective building insurability criteria from a set of absolute insurance standards including physical information, the number of units in the apartment complex or multi-unit dwelling complex to qualify the complex for fire insurance coverage, and regional actuarial fire and casualty insurance rates for covering a dwelling with renter's legal liability insurance. Next, the apartment or multi-unit dwelling is qualified in accordance with the objective building physical information and number of units, and the tenant data for renters legal liability insurance predetermined insurability criteria. Tenant insurance is then issued covering the building owner and/or property manager of the complex from the perils selected from the group comprising fire; smoke; explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures at a rate based on the number of insured units. The owner is then billed for the renter's legal liability insurance coverage.

FIG. 2 illustrates schematic flow diagram of a preferred configuration of the method of FIG. 1 performed by a computer apparatus. The method if performed by first inputting into a computer database relevant building physical information, occupancy information, and tenant rental information. This information is then expanded and tested by the computer employing a matching program to insure that there is one record per unit. Thus every unit is matched with a tenant, and any renter's insurance policy. Reports of incomplete data are then sent to the building owner or manager, or insurance carrier to update and correct their files. An insurance qualification procedure is executed to qualify the property for tenant insurance, and establish the periodic premiums for payment by the tenant. In some cases, a property may be qualified by default without going through the qualification process procedures.

From the uninsured tenant lists, the building owner or manager can take appropriate steps to enforce the lease provisions requiring tenant insurance coverage. In addition, the working database can be monthly audited and statistically sampled to insure its reliability. Generally, this process produces monthly internal audit reports and provides additional insurance leads to those tenants desiring additional insurance.

The second phase of the method allows the uninsured tenants to purchase directly on-line tenant occupancy insurance. The database is then updated and a bill prepared based on the total number of units in the building qualified for insurance and sent by the computer to the landlord for inclusion in the monthly rent charges for the insurance additional coverage.

This blanket insurance method can also be implemented via computer networks as illustrated in the co-pending parent applications described above.

The blanket insurance method and renters legal liability policy thus provides a novel insurance product, which can be issued manually or via technological assistance.

Although the foregoing specification refers to the illustrated embodiments, it is not intended to restrict the scope of the appended claims. The claims themselves recite those features deemed essential to the invention.

We claim:

1. A blanket insurance method for insuring an apartment or multi-unit dwelling unit with renters legal liability insurance covering the building owner from unintentional damage caused by the tenant from one or more of the perils selected from the group comprising fire; smoke; explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures, pursuant to predetermined insurability criteria comprising:
a. selecting objective building insurability criteria from a set of absolute insurance standards including physical information, the number of units in the apartment complex or multi-unit dwelling complex to qualify the complex for fire insurance coverage, actuarial insurance rates for renter's legal liability insurance, and other relevant information,
b. qualifying the apartment or multi-unit dwelling in accordance with the objective building physical information and number of units, and the tenant data for renters legal liability insurance pursuant to predetermined insurability criteria,
c. issuing tenant insurance covering the building owner and/or property manager of the complex from the perils selected from the group comprising fire; smoke; explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures at a rate based on the number of insured units, and
d. billing the owner for the renter's legal liability insurance coverage.

2. A blanket insurance method according to claim 1, wherein the building physical information comprises the full name of the insured, the mailing addresses of the building units, the number of buildings and units, the fire insurance policy on the building and rating by the four basic types of construction recognized in fire insurance coverage and including building owner coverage for negligence injuries by the tenant caused to third parties.

3. A blanket insurance method according to claim 1, including adding commission and management fees to the actuarial insurance rates for inclusion in the billings of the owner.

4. A blanket insurance method according to claim 3, wherein the tenant insurance information includes tenant rental information, which may include lease agreement requirements, the limits of coverage, a credit report on the tenant coded to meet legal confidentiality requirements, a criminal background check of the tenant, and a character reference check of the tenant to verify his past tenant conduct.

5. A blanket insurance method according to claim 1, wherein the building physical information and tenant rental information is inputted monthly.

6. A blanket insurance method according to claim 1, wherein the renters legal liability insurance covers both the owner and the tenant and the tenant's personal property within the unit.

7. A blanket insurance method according to claim 1, including generating tenant occupancy insurance which provides a pre-set amount of coverage for displaced tenants, and an additional sum for living expenses to the tenant unintentionally causing damage to the dwelling unit.

8. A blanket insurance method according to claim 6, wherein the renter's legal liability insurance covers the building owner's property for replacement cost.

9. A blanket insurance method according to claim 6, wherein the tenant occupancy insurance includes disability insurance, which pays the lease payment in the event an insured tenant is disabled.

10. A blanket insurance method according to claim 9, wherein the tenant occupancy insurance includes disability insurance, which also provides income benefits to the disabled tenant.

11. A blanket insurance method according to claim 10, wherein the tenant occupancy insurance includes an accidental death benefit payable to a beneficiary in the event of death of the tenant.

12. A blanket insurance method according to claim 1, wherein the owner is billed for renters legal liability and/or tenant occupancy insurance to be paid by the tenant on lease renewal or generation.

13. A blanket insurance method according to claim 12, wherein the provider of the renters legal insurance provides credits against policies covering the property owner who has 100% of the tenants' units insured.

14. A blanket insurance method according to claim 13, wherein the tenant occupancy insurance includes traditional HO-4 form policy coverage for the tenant.

15. A renter's legal liability insurance policy in a permanent written or unalterable media embodiment listing the coverage provided covering the unit according to the method of claim 1.

16. A renter's legal liability insurance policy according to claim 15, wherein the renter's legal liability insurance policy includes additional tenant occupancy insurance coverage, which also covers the tenant and the tenant's personal property in addition to damage to the unit.

17. A renter's legal liability insurance policy according to claim 12, wherein the tenant occupancy insurance coverage policy allows the tenant to acquire coverage by paying an additional insurance premium as part of the unit rent.

18. A blanket insurance method and policy according to claim 1, wherein the renters legal liability insurance to protect the landowner from unintentional damage caused by the tenant from two or more the perils selected from the group comprising fire, smoke, explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures, and negligence injuries by the tenant caused to third parties pursuant to predetermined insurability criteria.

19. A blanket insurance method policy according to claim 1, wherein the renters liability insurance protects the owner from unintentional damage caused by the tenant from three or more perils selected from the group comprising fire, smoke, explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures, and negligence injuries by the tenant caused to third parties pursuant to predetermined insurability criteria.

20. A blanket insurance method and policy according to claim 1, wherein the renters liability insurance protects the owner from unintentional damage caused by the tenant from four or more perils selected from the group comprising fire, smoke, explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures, and negligence injuries by the tenant caused to third parties pursuant to predetermined insurability criteria.
